(19) United States
(12) Patent Application Publication
(10) Pub. No.: US 2014/0169537 A1
(43) Pub. Date: Jun. 19, 2014

(54) NOTIFICATION TO A COMUNICATION DEVICE THAT A VOICE MAIL RECORDING IS IN PROGRESS

(71) Applicants: Ranjan Sharma, New Albany, OH (US); Yigang Cai, Naperville, IL (US)

(72) Inventors: Ranjan Sharma, New Albany, OH (US); Yigang Cai, Naperville, IL (US)

(21) Appl. No.: 13/715,072

(22) Filed: Dec. 14, 2012

(51) Int. Cl. H04M 3/533

(52) U.S. Cl. CPC H04M 3/5335
USPC 379/88.12

(57) ABSTRACT

Systems and methods are disclosed for providing a notification to a communication device indicating that a voice mail recording from a calling party is in progress. One embodiment comprises a voice mail entity of a communication network. The voice mail entity initiates a recording of a voice mail message from a calling party for a communication device, and provides an alert to the communication device indicating that the recording of the voice mail message is in progress. In another embodiment, the voice mail entity receives a request from the communication device to communicate with the calling party, determines if the recording is in progress, and forwards a call from voice mail entity to the communication device based on a determination that the recording is in progress.

### FIELD OF THE INVENTION

The invention is related to the field of communications and, in particular, to providing enhanced voice mail services for communication devices.

### BACKGROUND

Communication networks include voice mail services to allow calling parties to record voice mail for users of communication devices (i.e., called parties in this case) when the users and/or the communication devices are un-available or unreachable. Voice mail services are not embedded within the communication device, but rather, are provided as an external service to the communication device. The voice mail services are located externally to the communication device because in some cases, the communication device may be turned off, may be disconnected from the network, etc. Therefore, the voice mail services operate independently of the communication devices.

As used herein, calling parties and/or called parties may include a communication device (e.g., a mobile device, an Internet Protocol (IP) phone, a Voice over IP (VoIP) device, etc.), a user of the communication device, or some combination thereof. Voice mail services allow the user to retrieve, replay, and respond to the voice mail at a convenient time. While voice mail has generally become the fallback to real-time communications between parties, voice mail has a number of drawbacks. One drawback of voice mail occurs when the calling party is an international caller. International callers may incur a considerable expense to simply leave a recorded message for a user, when an email would likely have been a cheaper alternative to convey the same information. Another drawback of voice mail is the lack of timeliness. Leaving a voice mail and not being able to speak to the user is often considered ineffective, as the user may not be able to review the voice mail and respond in a timely fashion. In some ways, leaving a voice mail is similar to sending and receiving emails, which can be inefficient. Moreover, often the calling party is placing a voice call because the calling party recognizes that other forms of communication, such as email, may not be appropriate for the particular information that is being conveyed.

Yet another drawback to voice mail occurs when a user is waiting for a call, and the user misses the call by some miniscule amount of time, such as less than a minute. The calling party may then be recording a voice mail for the user, which makes it difficult for the user to reach the caller. Although the user may immediately call back after missing the call, if the calling party is actively recording a voice mail message for the user, then the calling party may not respond to the call attempt. This may result in various back and forth voice mail scenarios referred to as phone tag, which is inefficient.

### SUMMARY

Embodiments described herein provide an alert to a communication device indicating that a voice mail recording from a calling party is in progress. Rather than notifying the communication device in response to the completion of the recording of the voice mail message from the calling party, a voice mail entity of a communication network notifies the communication device that the recording of the voice mail message is ongoing.

One embodiment comprises an apparatus. The apparatus includes a voice mail entity that is configured to initiate a recording of a voice mail message from a calling party for a called party communication device. The voice mail entity is further configured to provide an alert to the called party communication device that the recording of the voice mail message is in progress.

In another embodiment, the voice mail entity is further configured to receive a request from the called party communication device to communicate with the calling party, to determine if the recording is in progress, and to forward a call from the voice mail entity to the called party communication device based on a determination that the recording is in progress.

In another embodiment, the voice mail entity is further configured to forward a notification to the calling party of the request to communicate from the called party communication device, and to forward the call from the voice mail entity to the called party communication device based on an acceptance by the calling party of the request to communicate.

In another embodiment, the notification to the calling party is provided over a voice path utilizing for the recording of the voice mail message.

In another embodiment, the apparatus further comprises the called party communication device. In this embodiment, the called party communication device is configured to present at least one of a graphical object and a text message in response to receiving the alert indicating that the recording is in progress. In other embodiments, the called party communication device is configured to generate at least one of a visible notification and an audible notification in response to receiving the alert indicating that the recording is in progress.

In another embodiment, the voice mail entity is further configured to initiate recording of a first voice mail message from a first calling party for the called party communication device, to initiate recording of a second voice mail message from a second calling party for the called party communication device, and to provide a first alert and a second alert to the called party communication device, where the first alert indicates that the recording of the first voice mail message is in progress, and where the second alert indicates that the recording of the second voice mail message is in progress.

In another embodiment, the called party communication device is configured to generate a first notification in response to receiving a first alert that a first recording is in progress, and to generate a second notification in response to receiving a second alert that a second recoding is in progress. The called party communication device is further configured to receive input from the user indicating a desire to communicate with one of the first calling party and the second calling party, to provide a request to the voice mail entity indicating the desire to communicate with a selected calling party based on the input, and to receive a forwarded call from the voice mail entity, the forwarded call from the selected calling party, in response to the request.

In another embodiment, the voice mail entity is configured to initiate recording of a plurality of voice mail messages for the called party communication device from a corresponding plurality of calling parties communication device, where the recording of the plurality of voice mail messages occurring at least partially simultaneously, and where the voice mail entity is configured to provide a respective alert for ones of the plurality of voice mail messages to the called party communication device indicating that the recording of the ones of the plurality of voice mail message is in progress

Another embodiment comprises a method of providing an alert to a called party communication device indicating that a voice mail recording from a calling party is in progress. The method comprises initiating, by a voice mail entity for a communication network, a recording of a voice mail message from a calling party for a called party communication device. The method further comprises providing an alert to the called party communication device indicating that the recording of the voice mail message is in progress.

Another embodiment comprises an apparatus. The Apparatus includes a communication device. The communication device is configured to receive an alert from a voice mail entity for a communication network indicating that a recording of a voice mail message from a calling party for the communication device is in progress. The communication device is further configured to provide a notification to a user indicating that the recording of the voice mail message is in progress.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 is a flow chart illustrating a method of providing an alert to a called party communication device indicating that a voice mail recording from a calling party is in progress in an exemplary embodiment.

FIG. 3 is a flow chart illustrating additional details of the method of FIG. 2 for providing a voice mail override in an exemplary embodiment.

FIG. 4 illustrates a communication device in an exemplary embodiment.

FIG. 5 is a flow chart illustrating a method of providing a voice mail override in an exemplary embodiment.

FIG. 6 illustrates an Internet Protocol Multimedia Subsystem (IMS) network in an exemplary embodiment.

FIG. 7 is a message diagram illustrating a call flow for providing a voice mail override in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

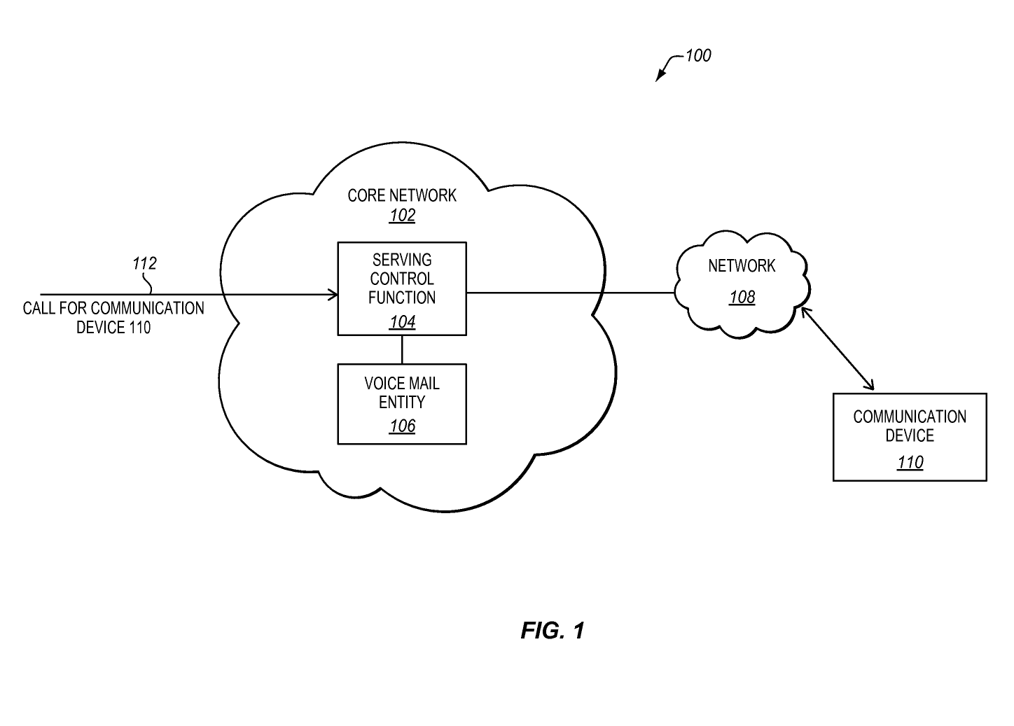

FIG. 1 illustrates a communication network 100 in an exemplary embodiment. Communication network 100 may be a Long Term Evolution (LTE) network, a Global System for Mobile (GSM) communications network, an Internet Protocol Multimedia Subsystem (IMS) network, or some other type of packet-switched or circuit-switched network. In this embodiment, communication network 100 has been enhanced to provide an alert to communication device 110 that a recording of a voice mail message for communication device 110 is in progress. For example, if a calling party places a call 112 for communication device 110 and the call is routed to voice mail to allow the calling party to record a voice message, then a voice mail entity 106 provides an alert to communication device 110 indicating that the recording is in progress. This allows a user of communication device 110 to make decisions about how to handle the missed call. Communication device 110 comprises any component, system, or device that is operable to receive the alerts from voice mail entity 106 indicating that a recording of a voice mail message is in progress. Some examples of communication device 110 include smart phones, tablets, VoIP phones, etc.

Communication network 100 in this embodiment includes a core network 102 and a network 108. Network 108 may be the Internet, a Radio Access Network (RAN), a Wi-Fi network, etc. Core network 102 in this embodiment includes a serving control function 104. Serving control function 104 generally provides control layer functions for core network 102. For example, serving control function 104 may be a Serving-Call Session Control Function (S-CSCF) in an Internet Protocol Multimedia Subsystem (IMS) architecture. However, serving control function 104 may also be a switch, a gateway, or some other type of control element in other types of communication networks.

Core network 102 in this embodiment also includes a voice mail entity 106. One example of voice mail entity 106 is an enhanced Voice Mail Server (VMS). Voice mail entity 106 in this embodiment comprises any component, system, or device that is operable to provide an alert to communication device 110 indicating that a recording of a voice mail message is in progress. Some examples of such an alert may include text messages (e.g., Short Message Service (SMS) messages and/or multimedia messages) provided to communication device 110, etc. In some embodiments, communication device 110 may provide a notification to user of communication device 110 in response to receiving the alert from voice mail entity 106 that the recording is in progress.

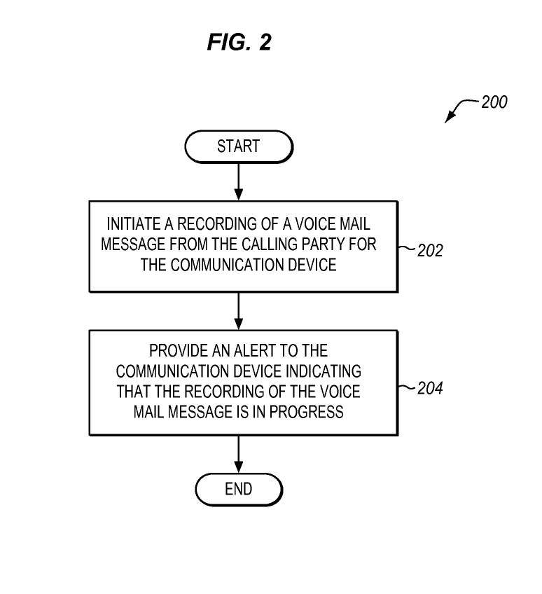

Providing the notification as the recording is in progress allows the user of communication device 110 to more efficiently respond to the missed call. For example, if communication device 110 receives an alert that the calling party is actively recording a voice mail, then a user may wait until the calling party is finished recording the message (e.g., via a message that a voice mail is pending and/or no longer recording for communication device 110) prior to attempting a call back to the calling party. This may improve the performance of communication network 100 by reducing or eliminating a phone tag scenario whereby the calling party, while recording a voice mail message for communication device 110, misses a call-back from the user of communication device 110. In another example, if communication device 110 receives an alert from voice mail entity 106 that the calling party is actively recording a voice mail, then in an optional embodiment, voice mail entity 106 forwards call 112 from voice mail entity 106 to communication device 110. This allows the user to talk with the calling party even though the calling party may have been in the process of recording a voice mail. This improves the performance of communication network 100 by reducing or eliminating the phone tag scenario whereby communication device 110 instructs voice mail entity 106 to abort, terminate, interrupt, suspend, etc., the voice mail recording session in progress by the calling party, and forwarding call 112 to communication device 110. How voice mail entity 106 may provide such enhanced voice mail features for communication device 110 will be discussed in more detail with regard to FIG. 2.

FIG. 2 is a flow chart illustrating a method 200 of providing an alert to communication device 110 indicates that a voice mail recording from a calling party is in progress in an exemplary embodiment. The steps of method 200 will be described with reference to voice mail entity 106 of communication network 100 of FIG. 1, but those skilled in the art will appreciate that method 200 may be performed by other systems that are not shown. The steps of the flow charts described herein are not all inclusive and may include other steps not shown. The steps may also be performed in an alternative order.

In this embodiment, assume that a calling party places call 112 for communication device 110, and call 112 goes to voice mail. Call 112 may go to voice mail for a number of reasons. For instance, a user of communication device 110 may not answer, calls for communication device 110 may configured to automatically go to voice mail, etc. Regardless, serving control function 104 places call 112 at voice mail entity 106 to allow a calling party to record a voice mail message.

In step 202, voice mail entity 106 provides an alert to communication device 110 indicating that the recording of the voice mail message from the calling party is in progress. Such alerts may include text messages initiated by and/or provided by voice mail entity 106 and/or other network elements of core network 102. For example, voice mail entity 106 may coordinate with an SMS server (not shown) of core network 102 to provide SMS messages to communication device 110. The alerts may thereafter may invoke a notification generated and/or presented by communication device 110 indicating that a voice mail message recording is in progress by the calling party, etc. In some embodiments, a user of communication device 110 may call into voice mail entity 106, thereby allowing voice mail entity 106 to notify the user that the recording is in progress over a voice path established between communication device 110 and voice mail entity 106.

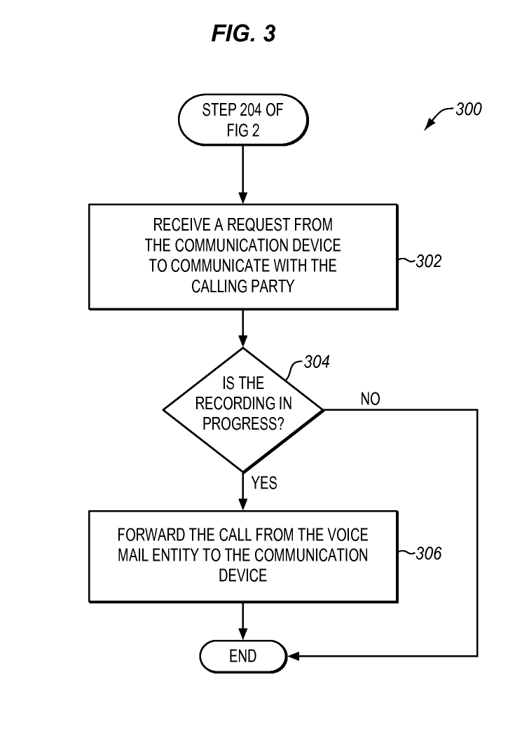

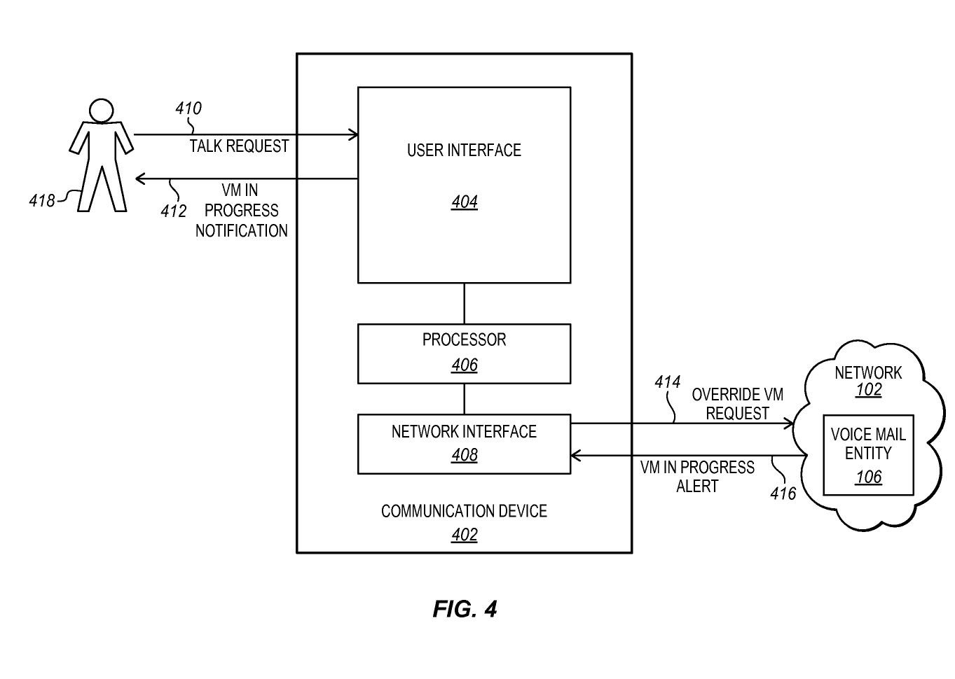

By voice mail entity 106 providing an alert for communication device 110 that the calling party is actively recording a voice mail, the user of communication device 110 may be provided a number of advantages over previous communication networks. For instance, the user of communication device 110, in response to being alerted that the calling party is recording a voice mail message, may elect to delay a call-back to the calling party until a another notification arrives indicating that the voice mail recording process is complete. The user of communication device 110 may also elect to contact the calling party during the recording process in other ways, such as by sending an SMS message to the calling party, establishing a call with the calling party utilizing a different phone number, sending an email to the calling party, etc. In some embodiments, the user of communication device 110 may choose to override the voice mail recording in progress by the calling party. These embodiments will be described in more detail with respect to FIGS. 3-4.

FIG. 3 is a flow chart illustrating additional details of method 200 of FIG. 2 for providing a voice mail override in an exemplary embodiment. The steps of method 300 illustrated in FIG. 3 will be described with reference to voice mail entity 106 of communication network 100 of FIG. 1, but those skilled in the art will appreciate that method 300 may be performed by other systems that are not shown. Method 300 begins after step 204 of FIG. 2.

In step 302, voice mail entity 106 receives a request from communication device 110 to communicate with the calling party. The request may be provided to voice mail entity 106 in a number of ways. For instance, the user of communication device 110 may press a hot button on a display of communication device 110 to cause the device to provide the request to voice mail entity 106; the user may call into voice mail entity 106 using communication device 110 and provide Dual Tone Multi-Frequency (DTMF) tones, voice commands, etc., to initiate the request to voice mail entity 106.

In step 304, voice mail entity 106 determines if the calling party is still recording the voice mail message for communication device 110. If the calling party is still recording the voice mail, then step 306 is performed. If the recording of the voice mail is no longer in progress, then method 300 ends.

In step 306, voice mail entity 106 forwards call 112 from voice mail entity 106 to communication device 110. The forwarded call 112 from voice mail entity 106 is not a new call, but rather is within the same call session established between the calling party and voice mail entity 106 for recording the voice mail message.

In some embodiments, voice mail entity 106 may notify the calling party during the recording of the voice mail message that the user of communication device 110 is available to talk. For example, in response to voice mail entity 106 receiving the request in step 302, voice mail entity 106 may notify the calling party that the user is now available. This may allow the calling party to choose whether or not to continue recording the voice mail message or rather, have call 112 forwarded to communication device 110 to allow the calling party to talk directly with the user of communication device 110.

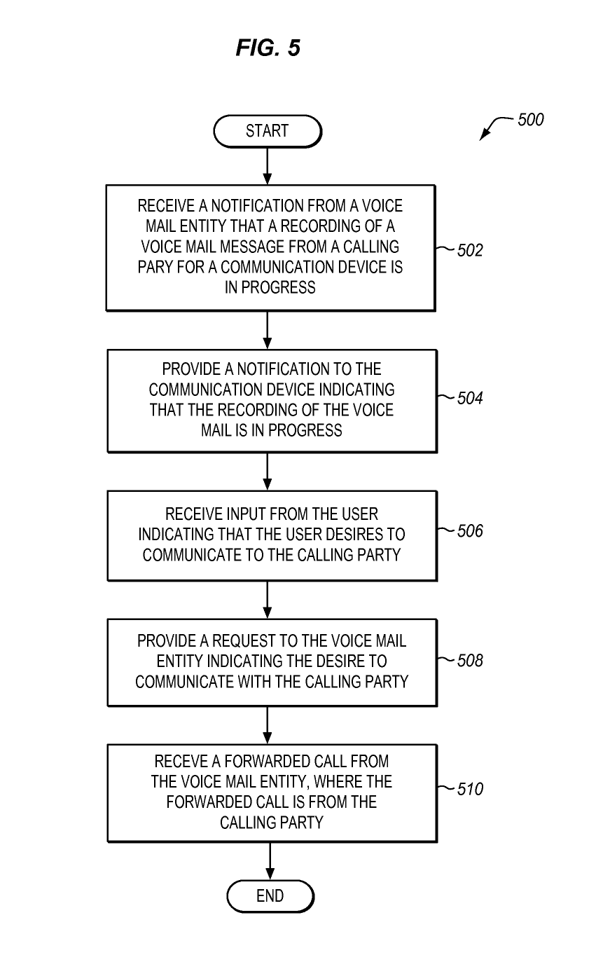

FIG. 4 illustrates a communication device 402 in an exemplary embodiment. In this embodiment, communication device 402 provides notifications 412 to a user 418 indicating that a recording of a voice mail from a calling party is in progress. Communication device 402 includes a user interface 404 (e.g., touch panel display on a smart phone, a display on a VoIP phone, etc.), a processor 406 (e.g., digital signal processors, custom circuits, etc.), and a network interface 408 (e.g., a RAN interface, an Ethernet interface, a Wi-Fi interface, etc.). Network interface 408 communicates with core network 102 to establish voice calls, send/receive data, etc. Generally, communication device 402 receives alert 416 from core network 102 that a voice mail recording is in progress. Communication device 402 then provides a notification 412 to user 418 indicating that the voice mail recording is in progress from a calling party. In some embodiments, user 418 may talk to the calling party if the recording is still in progress. User 418 may respond to notification 412 by requesting to override the voice mail recording in progress. This embodiment will be discussed in more detail with respect to FIG. 5.

FIG. 5 is a flow chart illustrating a method 500 of providing a voice mail override in an exemplary embodiment. The steps of method 500 will be described with reference to communication device 402 of FIG. 4, but those skilled in the art will appreciate that method 500 may be performed by other systems that are not shown.

Assume for this embodiment that a calling party makes a call for communication device 402. For some reason, the call goes to voice mail. The calling party begins recording a voice mail message.

In step 502, network interface 408 receives an alert 416 from voice message entity 106 of core network 102 that a voice mail recording is in progress. In step 504, processor 406 processes alert 416 and generates notification 412 for user 418. Notification 412 may be displayed on user interface 404, may be an audible signal for user 418, etc. or a combination thereof.

In step 506, user 418 observes notification 412 and makes a decision to communicate (e.g., talk) to the calling party. User 418 utilizes user interface 404 to provide an input 410 to communication device 402 indicating that user 418 wishes, desires, wants, etc., to communicate to the calling party. Processor 406 processes input 410 from user 418 and network interface 408, and provides a request 414 to voice mail entity 106 to communicate to the calling party in step 508. If the recording of the voice mail message is still in progress, then network interface 408 receives a forwarded call from voice mail entity 106, where the forwarded call is from the calling party, in step 510. This allows user 418 to override the voice mail recording process for the calling party and communicate directly to the calling party.

In some embodiments, communication device 402 may be actively involved in a call with a first calling party, while a second calling party is recording a voice mail message. In this embodiment, communication device 402 receives alert 416 from voice mail entity 106 indicating that the second calling party is recording a voice mail message during the active call between communication device 402 and the first calling party. Communication device 402 may then process the alert and generate notification 412 for user 418 indicating, during the active call with the first calling party, that the second calling party is recording a voice mail message. In response to notification 412, user 418 may elect to park the active call with the first calling party, and request a voice mail override for the recording in progress by the second calling party. Although only one example of a first party/second party interaction is discussed, one skilled in the art will recognize that a variety of combinations of call park and voice mail overrides are possible. For example, communication device 402 may receive a plurality of alerts, each regarding an active recording session of voice mails, and provide user 418 with the opportunity to decide which of the plurality of voice mail recording to override. This provides enhanced voice mail service by allowing for a prioritizing of the voice mail override activity.

### EXAMPLE

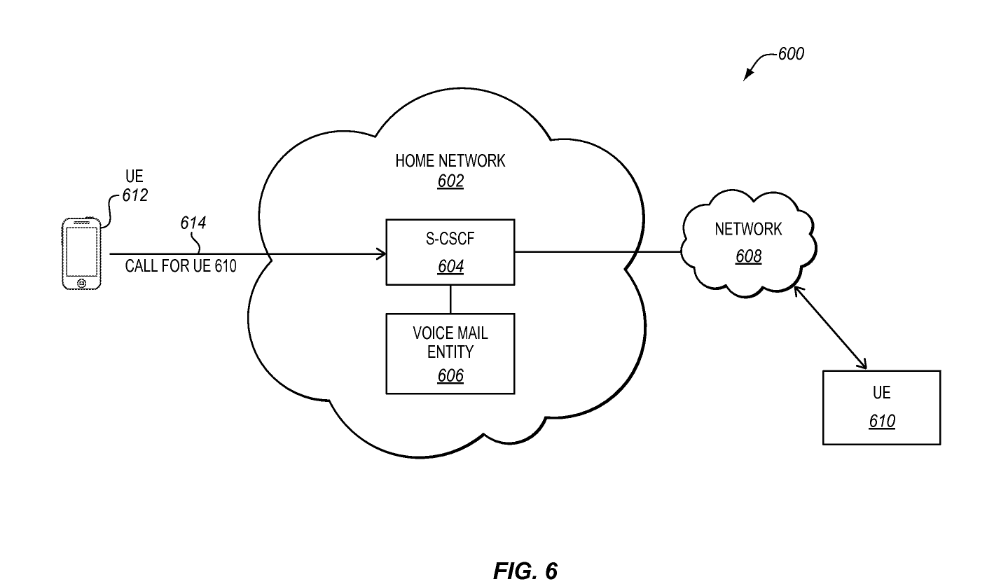

FIG. 6 illustrates an IMS communication network 600 in an exemplary embodiment. Communication network 600 includes a home network 602 for user equipment (UE) 610, a second UE 612, and a network 608 coupling UE 610 to home network 602.

Home network 602 includes a Serving-Call Session Control Function (S-CSCF) 604 that serves UE 610. In this embodiment, voice mail entity 606 has been enhanced to allow a user of UE 610 to override a voice mail recording from a calling party (e.g., a user of UE 612) to forward a call from voice mail entity 606 to UE 610.

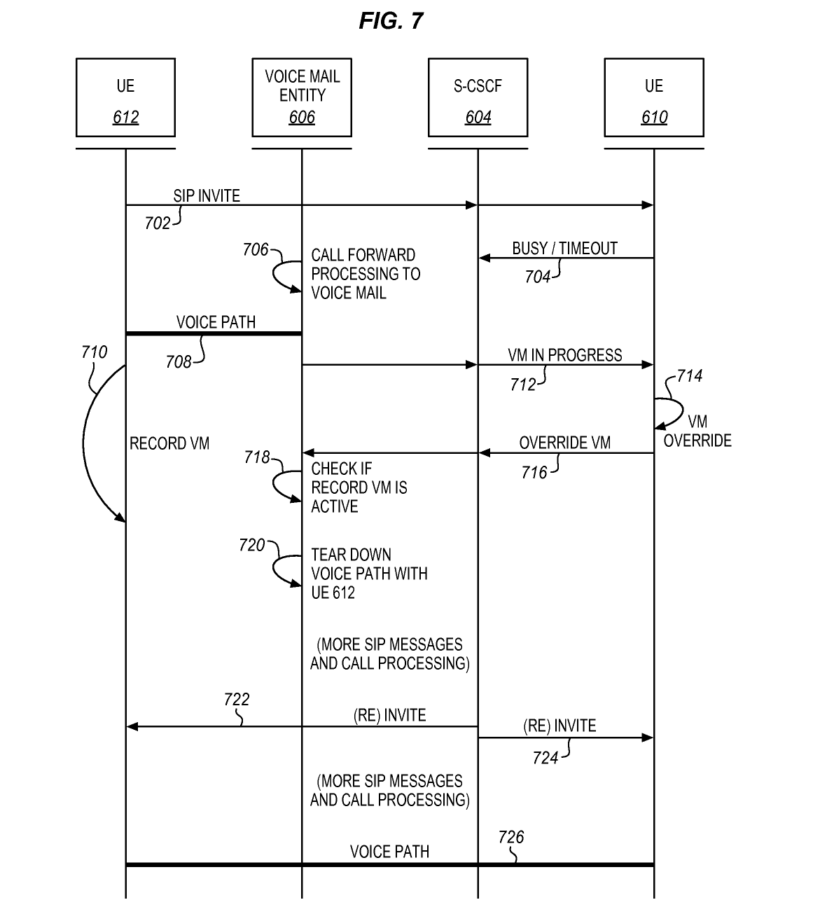

FIG. 7 is a message diagram illustrating a call flow for providing a voice mail override in an exemplary embodiment. Assume for this example that UE 612 (i.e., calling party communication device) places a call 614 to UE 610 (i.e., called party communication device). UE 612 transmits a SIP invite message to UE 610 to establish call 614 (see arrow 702). In this example, a user of UE 610 is not available to take the call (see arrow 704). This may occur if a user of UE 610 is busy on another call, or there is a timeout/no answer condition. Various SIP messages are exchange to implement call forwarding to voice mail entity 606 (see arrow 706). A voice path is created between UE 612 and voice mail entity 606 for recording a voice mail message for the user of UE 610 (see voice path 708). A user of UE 612 begins recording a voice mail message (see arrow 710). An alert is provided to UE 610 indicating that the voice mail recording is in progress (see arrow 712). UE 610 provides a notification to the user indicating that the recording is in progress. A user of UE 610 decides to override the voice mail in progress for the user of UE 612 (see arrow 714). In response, UE 610 transmits a message to voice mail entity 606 to override (see arrow 716). Voice mail entity 106 may then provide a notification to UE 612 indicating that UE 610 is now available to talk. For instance, voice mail entity 606 may provide various tones, voice prompts, etc., over voice path 708 to the user of UE 612. Voice mail entity 606 checks if the voice mail recording is still in progress. If the recording is in progress, call processing is performed to forward the call from voice mail entity 606 to UE 610, which may depend on the assent of the calling party (e.g., a user of UE 612). The voice path with UE 610 is torn down (see arrow 720). This involves a number of SIP messages and call processing that is not shown. A (re) invite for call 614 is provided to UE 612 (see arrow 722). A (re) invite for call 614 is also provided to UE 610 (see arrow 724). More SIP messages and call processing is performed (not shown). A voice path 726 is thereafter established between UE 612 and UE 610 to override the voice mail process and talk directly to the user of UE 612.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. An apparatus comprising:
a voice mail entity for a communication network, the voice mail entity configured to initiate a recording of a voice mail message from a calling party for a called party communication device, and to provide an alert to the called party communication device indicating that the recording of the voice mail message is in progress.

2. The apparatus of claim 1 wherein:
the voice mail entity is further configured to receive a request from the called party communication device to communicate with the calling party, to determine if the recording is in progress, and to forward a call from the voice mail entity to the called party communication device based on a determination that the recording is in progress.

3. The apparatus of claim 2 wherein:
the voice mail entity is further configured to forward a notification to the calling party of the request to communicate from the called party communication device, and to forward the call from the voice mail entity to the called party communication device based on an acceptance by the calling party of the request to communicate.

4. The apparatus of claim 3 wherein:
the notification to the calling party is provided over a voice path utilized for the recording of the voice mail message.

5. The apparatus of claim 1 further comprising:
the called party communication device, wherein the called party communication device is configured to present at least one of a graphical object and a text message in response to receiving the alert indicating that the recording is in progress.

6. The apparatus of claim 1 further comprising:
the called party communication device, wherein the called party communication device is configured to generate at least one of a visible notification and an audible notification in response to receiving the alert indicating that the recording is in progress.

7. The apparatus of claim 1 wherein:
the voice mail entity is further configured to initiate recording of a first voice mail message from a first calling party for the called party communication device, to initiate recording of a second voice mail message from a second calling party for the called party communication device, and to provide a first alert and a second alert to the called party communication device,
wherein the first alert indicates that the recording of the first voice mail message is in progress, and
wherein the second alert indicates that the recording of the second voice mail message is in progress.

8. The apparatus of claim 7 further comprising:
the called party communication device, wherein the called party communication device is configured to generate a first notification in response to receiving the first alert that the first recording is in progress, and to generate a second notification in response to receiving the second alert that the second recoding is in progress; and
the called party communication device is further configured to receive input from the user indicating a desire to communicate with one of the first calling party and the second calling party, to provide a request to the voice mail entity indicating the desire to communicate with a selected calling party based on the input, and to receive a forwarded call from the voice mail entity, the forwarded call from the selected calling party, in response to the request.

9. The apparatus of claim 1 wherein:
the voice mail entity is configured to initiate recording of a plurality of voice mail messages for the called party communication device from a corresponding plurality of calling parties communication device, the recording of the plurality of voice mail messages occurring at least partially simultaneously, and wherein the voice mail entity is configured to provide a respective alert for ones of the plurality of voice mail messages to the called party communication device indicating that the recording of the ones of the plurality of voice mail message is in progress.

10. A method comprising:
initiating, by a voice mail entity for a communication network, a recording of a voice mail message from a calling party for a called party communication device; and
providing an alert to the called party communication device indicating that the recording of the voice mail message is in progress.

11. The method of claim 10 further comprising:
receiving a request from the called party communication device to communicate with the calling party;
determining if the recording is in progress; and
forwarding a call from the voice mail entity to the called party communication device based on a determination that the recording is in progress.

12. The method of claim 11 further comprises:
forwarding a notification to the calling party of the request to communicate from the called party communication device; and
wherein forwarding the call further comprises:
forwarding the call from the voice mail entity to the called party communication device based on an acceptance by the calling party of the request to communicate.

13. The method of claim 12 wherein:
the notification to the calling party is provided over a voice path utilized for the recording of the voice mail message.

14. The method of claim 10 further comprising:
presenting, by the called party communication device, at least one of a graphical object and a text message in response to receiving the alert indicating that the recording is in progress.

15. The method of claim 10 further comprising:
generating, by the called party communication device, at least one of a visible notification and an audible notification in response to receiving the alert indicating that the recording is in progress.

16. An apparatus comprising:
a communication device configured to receive an alert from a voice mail entity for a communication network indicating that a recording of a voice mail message from a calling party for the communication device is in progress, and to provide a notification to a user indicating that the recording of the voice mail message is in progress.

17. The apparatus of claim 16 wherein:
the communication device is further configured to receive input from the user indicating a desire to communicate with the calling party, to provide a request to the voice mail entity indicating the desire to communicate with the calling party, and to receive a forwarded call from the voice mail entity, the forwarded call from the calling party, in response to the request.

18. The apparatus of claim 16 wherein:
the communication device is further configured to present a text message to provide the notification to the user.

19. The apparatus of claim 16 wherein:
the communication device is further configured to generate an audible signal to provide the notification to the user.

20. The apparatus of claim 16 wherein:
the communication device is further configured to display a graphical object to provide the notification to the user.

21. The apparatus of claim 18 wherein:
the communication device is further configured to identify a selection of the graphical object indicating a desire to communicate with the calling party, to receive a notification from the voice mail entity indicating that the recording of the voice mail message is completed, and to terminate the display of the graphical object in response to the notification.
